(19) United States
(12) Patent Application Publication
(10) Pub. No.: US 2024/0228245 A1
(43) Pub. Date: Jul. 11, 2024

(54) Multi-Purpose Tool

(71) Applicant: Jason Alen Marburger, Spokane, WA (US)

(72) Inventor: Jason Alen Marburger, Spokane, WA (US)

(21) Appl. No.: 18/408,110

(22) Filed: Jan. 9, 2024

Related U.S. Application Data
(60) Provisional application No. 63/479,116, filed on Jan. 9, 2023.

(51) Int. Cl. B66F 3/10; B25B 1/10; B66F 3/12

(52) U.S. Cl. CPC B66F 3/10; B25B 1/103; B66F 3/12

(57) ABSTRACT

Implementations provide a multi-purpose tool that is configurable and reconfigurable to accommodate a wide variety of tasks. For instance, implementations of the multi-purposes tool include a vise mechanism that can be used to secure objects such as workpieces. Further, implementations of the multi-purposes tool include reconfigurable lift mechanisms that can be used to lift objects.

### RELATED APPLICATION

This application claims priority to U.S. Provisional Application Ser. No. 63/479,116 filed Jan. 9, 2023, entitled “Multi-Purpose Tool,” the disclosure of which is incorporated by reference herein in its entirety.

### BACKGROUND

A number of different tools are available for lifting heavy objects (e.g., a vehicle), such as a scissor jack, a high lift jack, a single arm jack, etc. Further, a vise such as a bench vise can be used to secure items such as a workpiece. Such tools, however, are typically single purpose in nature and thus are difficult to adapt for tasks outside of their specified design.

### SUMMARY

Implementations provide a multi-purpose tool that is configurable and reconfigurable to accommodate a wide variety of tasks. For instance, implementations of the multi-purposes tool include a vise mechanism that can be used to secure objects such as workpieces. Further, implementations of the multi-purpose tool include reconfigurable lift mechanisms that can be used to lift objects. The lift mechanisms, for instance, can be implemented as different types of jacks that can be used to lift heavy objects such as vehicles, machinery, and other objects. Thus, the described multi-purpose tool provides a number of different useful functionality that is adaptable to perform a variety of different tasks.

### BRIEF DESCRIPTION OF THE DRAWINGS

The detailed description is described with reference to the accompanying figures. Entities represented in the figures may be indicative of one or more entities and thus reference may be made interchangeably to single or plural forms of the entities in the discussion.

FIG. 1 depicts an example implementation of a multi-purpose tool in accordance with one or more implementations.

FIG. 2 depicts different examples of components that are usable as part of a multi-purpose tool in accordance with one or more implementations.

FIGS. 3A and 3B depict different views of a link mechanism utilizable to enable different implementations of a multi-purpose tool in accordance with one or more implementations.

FIG. 4 depicts an example implementation of the multi-purpose tool in a scissor jack configuration in accordance with one or more implementations.

FIG. 5 depicts an example implementation of the scissor jack in a scenario for lifting an object in accordance with one or more implementations.

FIG. 6 depicts an example implementation of the multi-purpose tool in a single arm jack implementation in accordance with one or more implementations.

FIG. 7 depicts an example implementation of the single arm jack utilized in a scenario for lifting an object in accordance with one or more implementations.

FIG. 8 depicts an example implementation of the multi-purpose tool in a high lift jack implementation in accordance with one or more implementations.

FIG. 9 depicts an example implementation of high lift jack utilized in a scenario for lifting an object in accordance with one or more implementations.

FIG. 10 depicts an example implementation of the multi-purpose tool in a hitch vise implementation in accordance with one or more implementations.

FIG. 11 depicts an example implementation of the hitch vise utilized in a scenario in accordance with one or more implementations.

FIG. 12 depicts an example implementation of the hitch vise utilized in a scenario in accordance with one or more implementations.

FIGS. 13A, 13B, and 13C depict implementations for using the link mechanism in conjunction with the multi-purpose tool in accordance with one or more implementations.

FIG. 14 depicts an implementation of the multi-purpose tool in a scenario for attachment to an adjacent surface.

### DETAILED DESCRIPTION

### Overview

A multi-purpose tool is described. The multi-purpose tool, for instance, is modular and can be implemented in a variety of different implementations and in multiple different configurations, such as different jack implementations that can be used for lifting objects, vise orientations for gripping objects, and combinations thereof. A same set of components of the multi-purpose tool, for example, is reconfigurably interoperable to provide a variety of different implementations for performing a variety of different tasks.

### Multi-Purpose Tool

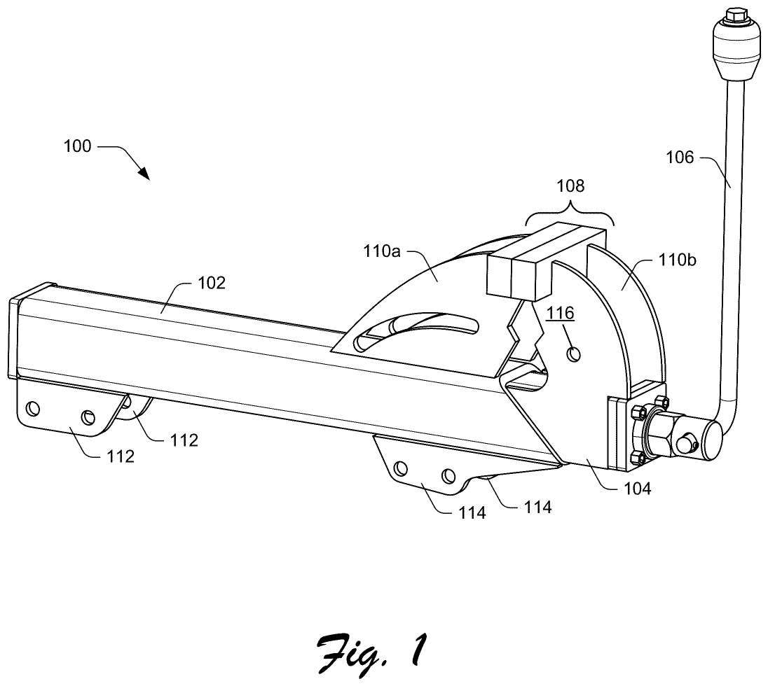

FIG. 1 depicts an example implementation of a multi-purpose tool 100 in accordance with one or more implementations. The multi-purpose tool 100 includes a tool body 102, a tool insert 104 that is slidably inserted into the tool body 102, and a handle 106 operably attached to the tool insert 104. The multi-purpose tool 100 also includes a vise mechanism 108 including a first jaw 110a and a second jaw 110b. The first jaw 110a, for instance, represents a jaw structure that is attached to and/or formed as part of the tool body 102, and the second jaw 110b represents a jaw structure that is attached to and/or formed as part of the tool insert 104.

The handle 106 is operable to open and close the vise mechanism 108, such as to enable an object to be placed and secured within the vise mechanism 108. For instance, manipulation of the handle 106 can cause slidable movement of the tool insert 104 within the tool body 102 and thus cause extension and contraction of the tool insert 104 relative to the tool body 102, such as to enable different operation scenarios discussed herein. Further, extension and contraction of the tool insert 104 relative to the tool body 102 causes corresponding movement of the second jaw 110b relative to the first jaw 110a. For instance, the tool body 102 and/or the tool insert 104 include an internal mechanism (e.g., screw mechanism, hydraulic mechanism, etc.) that when rotated causes the tool insert 104 to slide within the tool body 102, e.g., to extend and contract relative to the tool body 102. The handle 106, for example, is attached to a screw mechanism such that rotation of the handle 106 causes corresponding rotation of the screw mechanism which in turn causes corresponding sliding movement of the tool insert 104 within the tool body 102.

The multi-purpose tool 100 further includes a set of brackets 112 and a set of brackets 114 attached to and/or formed as part of the tool body 102. The brackets 112, 114, for instance, extend from the tool body 102 and include apertures (e.g., holes) via which objects can be attached to the brackets 112, 114 and thus to the multi-purpose tool 100. The second jaw 110b includes an aperture 116 that can accept various types of fasteners (e.g., a pin) to enable object attachment to the second jaw 110b and thus to the multi-purpose tool 100.

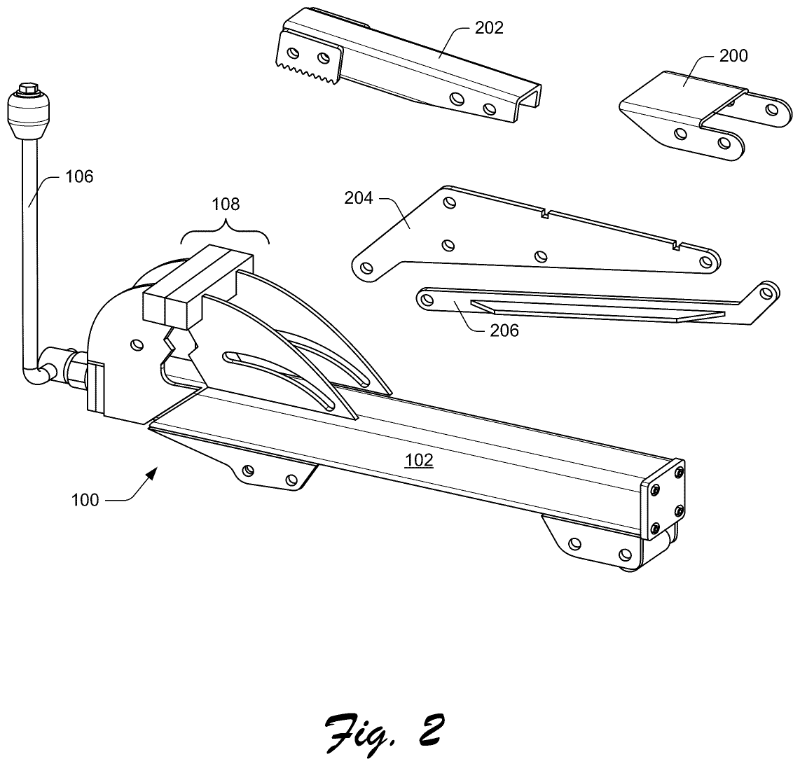

FIG. 2 depicts different examples of components that are usable as part of a multi-purpose tool 100 in accordance with one or more implementations. For instance, the multi-purpose tool 100 is illustrated including the tool body 102, the vise mechanism 108, and the handle 106. Further, a lift platform 200 and a link mechanism 202 are illustrated. Further illustrated are a lift arm 204 and an extension arm 206. As further described below the different mechanisms can support different implementations and variations of the multi-purpose tool 100. For instance, the different components depicted in FIG. 2 are attachable and detachable from the multi-purpose tool 100 to reconfigurably form various implementations described herein.

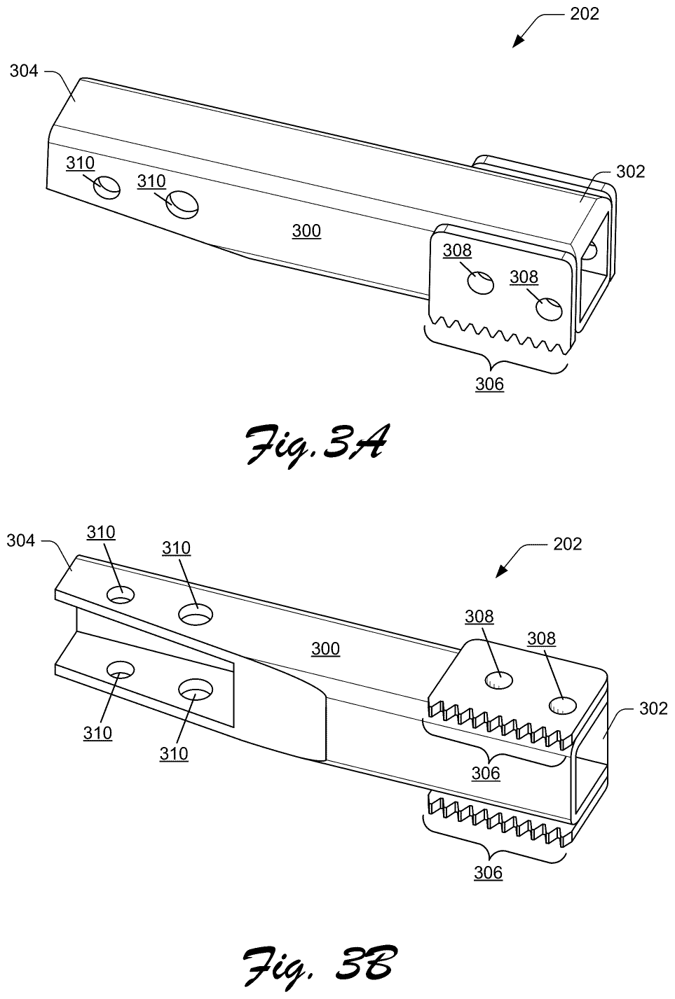

FIGS. 3A and 3B depict different views of a link mechanism utilizable to enable different implementations of a multi-purpose tool in accordance with one or more implementations. For instance, FIG. 3A represents a top view of the link mechanism 202 and FIG. 3B represents a bottom view of the link mechanism 202. The link mechanism 202, for example, includes a link body 300 with a first end 302 and a second end 304. The first end 302 and the second end 304 can be utilized in various ways to enable different configurations and functionalities of a multi-purpose tool 100. The first end 302 also includes teeth 306, such as to aid in engaging with an object such as within a hitch receiver of a vehicle to mitigate slippage when lifting the vehicle.

The first end 302 includes apertures 308 and the second end 304 includes apertures 310. The apertures 308, 310 can be utilized for various purposes, such as for attaching the link mechanism 202 to the multi-purpose tool 100 and/or an object to enable different implementations of the multi-purpose tool 100.

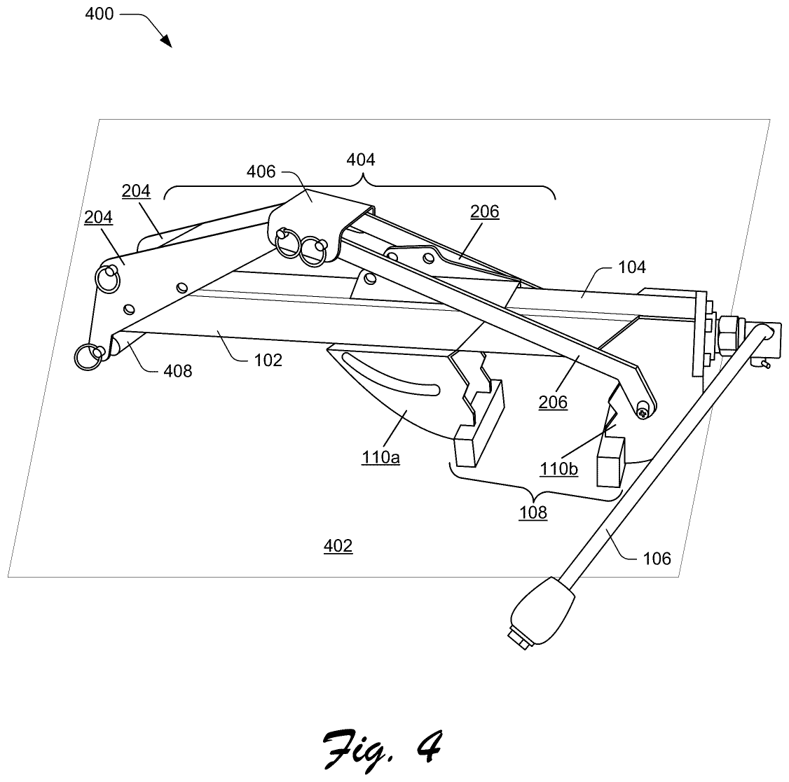

FIG. 4 depicts an example implementation of the multi-purpose tool 100 in a scissor jack 400 configuration in accordance with one or more implementations.

In this particular depiction the scissor jack 400 is positioned on a surface 402 such as to enable the scissor jack 400 to be utilized for lifting an object. The scissor jack 400 includes a lift mechanism 404 including a lift platform 406, lift arms 204, and extension arms 206. The lift arms 204, for instance, are attached to respective brackets 112 (not visible here) such as via fasteners and the extension arms 206 are attached to the second jaw 110b, such as via fastener insertion into the apertures 116 depicted in FIG. 1. Further, the lift arms 204 and the extension arms 206 are attached to the lift platform 406, such as via fasteners inserted into apertures in the lift arms 204, the extension arms 206, and lift platform 406.

The scissor jack 400 further includes a jack foot 408 attached at a peripheral end of the lift arms 204 such as via fasteners. The jack foot 408, the first jaw 110a, and the second jaw 110b can be placed on the surface 402 and the lift platform 406 can be placed against an object to enable the scissor jack 400 to be used to lift the object. For instance, rotation of the handle 106 in a first direction (e.g., clockwise) causes the tool insert 104 to slidably move inwards into the tool body 102 which in turn causes the lift mechanism 404 to extend away from the tool body 102, such as for lifting an object placed against the lift platform 406. Further, rotation of the handle 106 in a second direction (e.g., counterclockwise) causes the tool insert 104 to slidably move outwards relative to the tool body 102 which in turn causes the lift mechanism 404 to retract inward toward the tool body 102, such as for lowering an object placed against the lift platform 406.

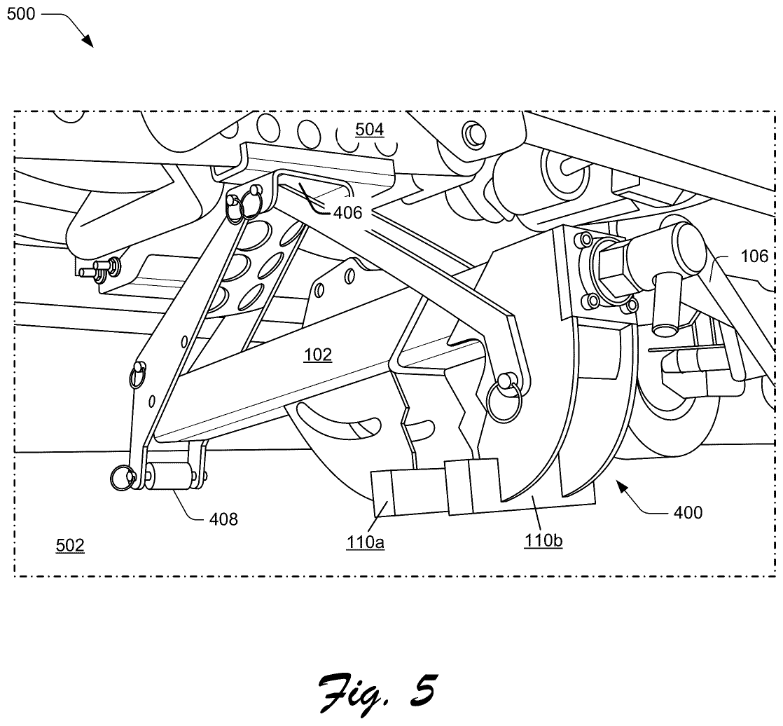

FIG. 5 depicts an example implementation of the scissor jack 400 in a scenario 500 for lifting an object in accordance with one or more implementations. In the scenario 500 the jack foot 408, the first jaw 110a, and the second jaw 110b are positioned on a surface 502. Further, the lift platform 406 is positioned against an object 504. The scissor jack 400 can be operated to manipulate a position of the object 504. For instance, by rotating the handle 106 clockwise or counterclockwise, the lift platform 406 can be raised and lowered to manipulate the object 504 in an upward or downward direction.

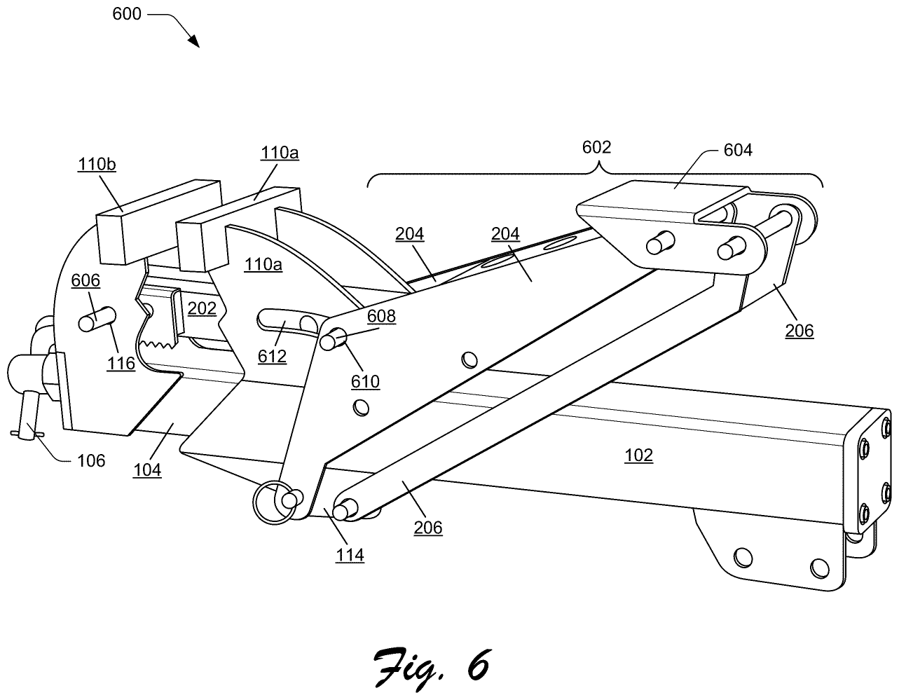

FIG. 6 depicts an example implementation of the multi-purpose tool 100 in a single arm jack 600 implementation in accordance with one or more implementations. The single arm jack 600 includes a lift mechanism 602 including a lift platform 604, the lift arms 204, and the extension arms 206. The lift arms 204 are attached to the brackets 114 at first ends of the lift arms 204 and are attached to the lift platform 604 at second ends of the lift arms 204. The extension arms 206 are attached to the brackets 114 at first ends of the extension arms 206 and are attached to the lift platform 604 at second ends of the extension arms 206.

The single arm jack 600 includes the link mechanism 202 that can be utilized to enable different configurations and functionalities of the multi-purpose tool 100. The link mechanism 202, for instance, can be positioned internally within the first jaw 110a and the second jaw 110b to enable operation of the single arm jack 600. In this arrangement, for example, the link mechanism 202 is substantially parallel to the tool body 102.

In the single arm jack 600 implementation the link mechanism 202 is attached to the second jaw 110b at the first end 302 of the link mechanism 202 and is attached to the lift arms 204 at the second end 304 of the link mechanism 202. For instance, a fastener 606 is placed through the apertures 116 on both sides of the second jaw 110b as well as through an aperture 308 (depicted in FIGS. 3A, 3B) through the first end 302 of the link mechanism 202. The fastener 606, for instance, secures the first end 302 of the link mechanism 202 to the second jaw 110b.

Further, a fastener 608 is placed through apertures 610 of the lift arms 204 and through an aperture 310 in the second end 304 of the link mechanism 202 (depicted in FIGS. 3A, 3B, not visible here). The fastener 608 also passes through guide channels 612 in both sides of the first jaw 110a. The guide channels 612, for instance, represent elongated perforations within the first jaw 110a through which the fastener 608 can travel during movement of the lift mechanism 602.

According to implementations of the single arm jack 600, slidable movement of the tool insert 104 causes upward and downward movement of the lift platform 604 relative to the tool body 102. For instance, rotating the handle 106 in a first direction causes the tool insert 104 to slide outwardly relative to the tool body 102 and causes the lift platform 604 to move upwardly relative to the tool body 102. Further, rotating the handle 106 in a second direction causes the tool insert 104 to slide inwardly relative to the tool body 102 and causes the lift platform 604 to move downwardly relative to the tool body 102.

For example, engagement of the fastener 606 with the second jaw 110b and the link mechanism 202 causes the link mechanism 202 to move along with movement of the tool insert 104. The link mechanism 202, for example, moves substantially parallel to the tool body 102 and the tool insert 104 based on movement of the tool insert 104. Further, engagement of the fastener 608 with the link mechanism 202 and the lift arms 204 causes the lift arms 204 and thus the lift platform 604 and the extension arms 206 to move along with movement of the link mechanism 202. Engagement of the fastener 608 within the guide channels 612 guides movement of the lift mechanism 602 and secures the lift mechanism 602 to the first jaw 110a. Thus, the link mechanism 202 is operable to transfer force and/or power from movement of the tool insert 104 and the second jaw 110b to the lift arms 204 and thus to the lift mechanism 602, e.g., to cause upward and downward movement of the lift platform 604. Further, the lift arms 204 and the extension arms 206 can be substantially parallel in the single arm jack 600 implementation of the multi-purpose tool 100.

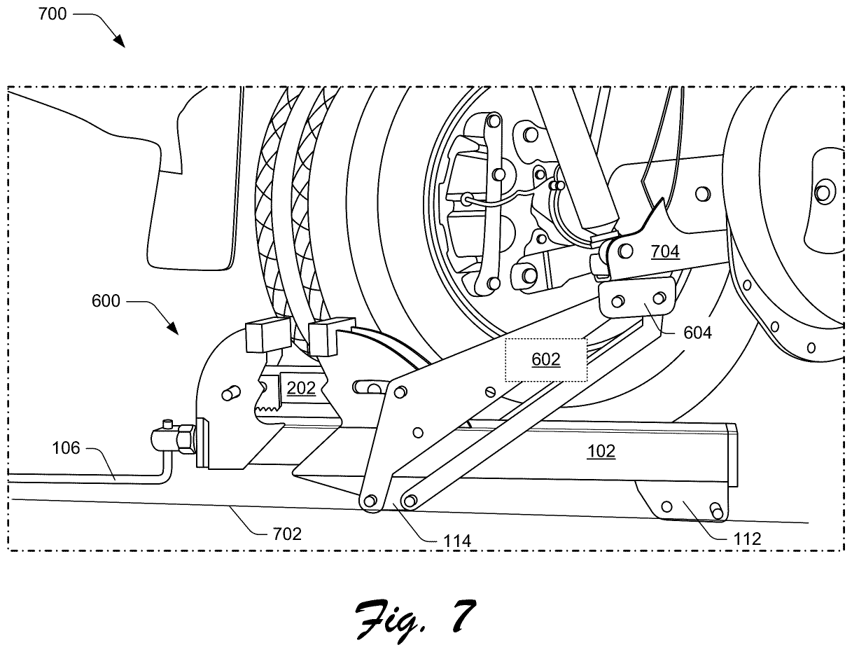

FIG. 7 depicts an example implementation of the single arm jack 600 utilized in a scenario 700 for lifting an object in accordance with one or more implementations. In the scenario 700 the brackets 112, 114 are placed against a surface 702 and thus can serve as supports (e.g., feet) for the single arm jack 600. Further, the lift platform 604 is placed against an object 704. Accordingly, the lift platform 604 can be manipulated to raise and lower the object 704, such as via clockwise and counterclockwise rotation of the handle 106. Further, the link mechanism 202 is operable to transfer force and/or power from a mechanism within the tool body 102 (e.g., a screw mechanism) to the lift mechanism 602 to enable upward and downward movement of the lift platform 604 relative to the tool body 102.

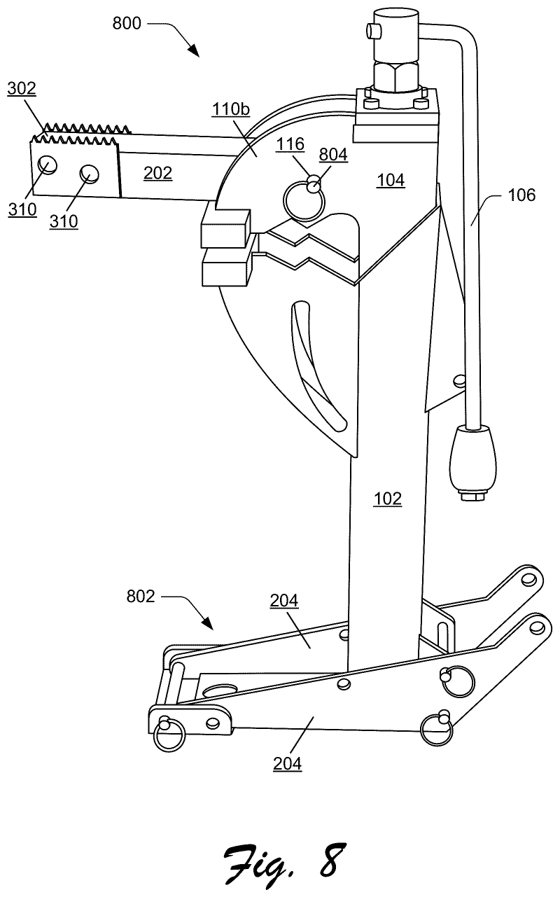

FIG. 8 depicts an example implementation of the multi-purpose tool 100 in a high lift jack 800 implementation in accordance with one or more implementations. The high lift jack 800 includes the tool body 102, the tool insert 104, and the handle 106 arranged such as discussed above. The high lift jack 800 utilizes the lift arms 204 as a support mechanism 802, e.g., a jack foot for the high lift jack 800. The support mechanism 802, for example, can be placed against a surface as part of utilizing the high lift jack 800.

The high lift jack 800 utilizes the link mechanism 202 as an engagement member for engaging with objects to be moved. In the high lift jack 800 arrangement the link mechanism 202 is placed across the second jaw 110b and thus the second jaw 110b supports the link mechanism 202. Further, the link mechanism 202 is fastened to the second jaw 110b via a fastener 804 that passes through the apertures 116 in the second jaw 110b and an aperture 310 in the second end 304 of the link mechanism 202. The link mechanism 202, for instance, is pivotably attached to the second jaw 110b about the fastener 804. In this arrangement the link mechanism 202 is substantially perpendicular to the tool body 102.

The first end 302 of the link mechanism 202 can be placed against and/or within an object to enable movement of the object via the high lift jack 800. Further, fasteners can be placed through an object and through the apertures 308 to secure the high lift jack 800 to an object to be moved.

According to implementations of the high lift jack 800, slidable movement of the tool insert 104 causes upward and downward movement of the link mechanism 202 relative to the tool body 102. For instance, rotating the handle 106 in a first direction causes the tool insert 104 to slide outwardly relative to the tool body 102 and causes the link mechanism 202 to move upwardly relative to the tool body 102. Further, rotating the handle 106 in a second direction causes the tool insert 104 to slide inwardly relative to the tool body 102 and causes the link mechanism 202 to move downwardly relative to the tool body 102.

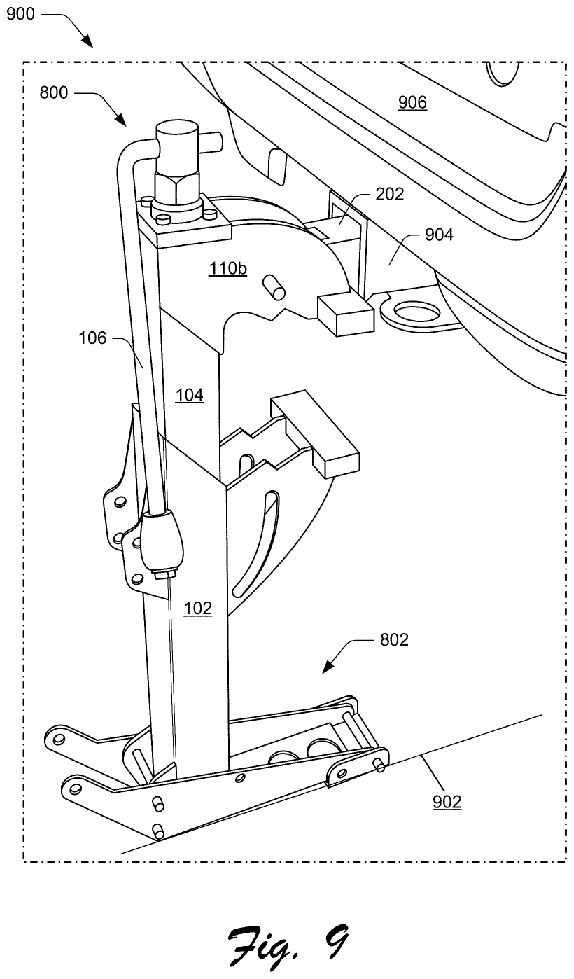

FIG. 9 depicts an example implementation of high lift jack 800 utilized in a scenario 900 for lifting an object in accordance with one or more implementations. In the scenario 900 the support mechanism 802 is placed on a surface 902 and the link mechanism 202 is inserted into a receptacle 904 of an object 906 to enable the high lift jack 800 to be utilized to lift the object 906. In at least one implementation the object 906 is a vehicle and the receptacle 904 is a hitch receiver of the vehicle.

To manipulate the high lift jack 800, the handle 106 can be rotated to cause the second jaw 110b to move upwardly relative to the surface 902 and apply force to the link mechanism 202 effective to lift the object 906. For instance, rotating the handle in a first direction causes the tool insert 104 to slidably move outward from within the tool body 102 and causes the link mechanism 202 to apply pressure to the object 906 from within the receptacle 904. The applied force can cause the object 906 to be lifted relative to the adjacent surface 902. Further, rotating the handle 106 in a second direction can lower the object 906 relative to the surface 902.

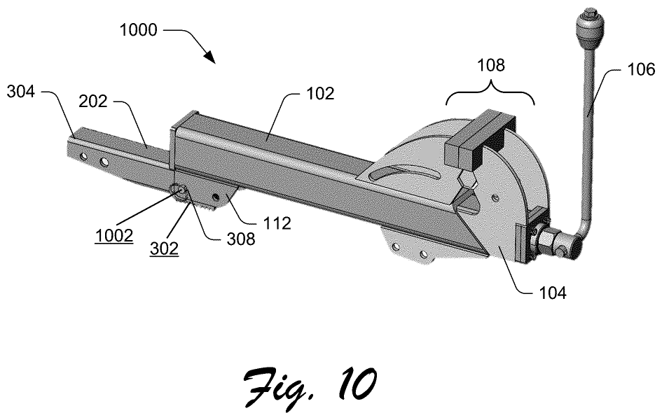

FIG. 10 depicts an example implementation of the multi-purpose tool 100 in a hitch vise 1000 implementation in accordance with one or more implementations. In the hitch vise 1000 implementation the tool body 102, tool insert 104, and handle 106 are arranged as discussed previously. Further, the link mechanism 202 is fastened to the brackets 112 via a fastener 1002 placed through apertures in the brackets 112 and an aperture 308 in the first end 302 of the link mechanism 202. In the hitch vise 1000 arrangement the link mechanism 202 supports the tool body 102 and the link mechanism 202 is substantially parallel to the tool body 102. The second end 304 of the link mechanism 202 can be placed within a receptacle of an object (e.g., a hitch receiver of a vehicle) to secure the hitch vise 1000 and enable use of the vise mechanism 108, such as for securing a workpiece within the vise mechanism 108.

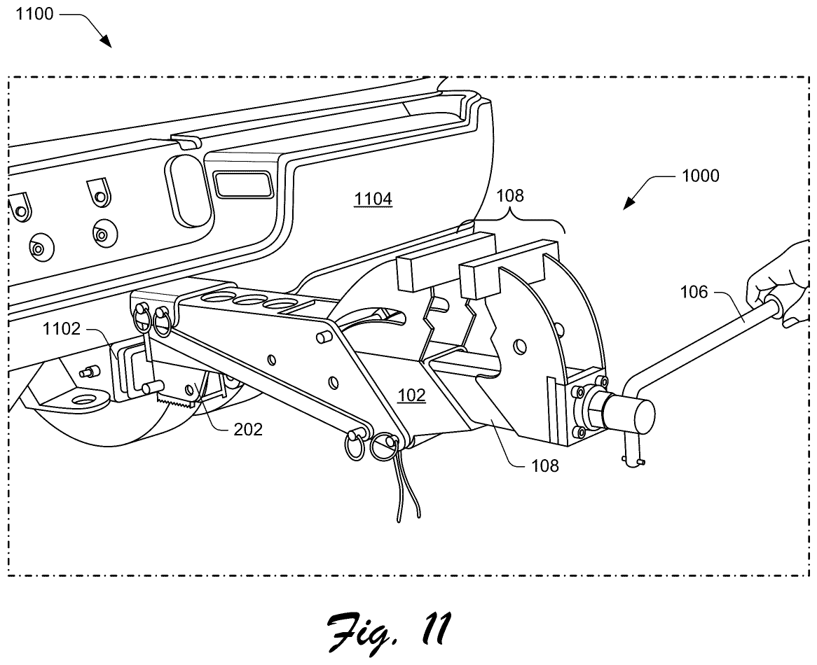

FIG. 11 depicts an example implementation of the hitch vise 1000 utilized in a scenario 1100 in accordance with one or more implementations. In the scenario 1100 the link mechanism 202 is placed within a receptacle 1102 (e.g., a hitch receiver) of an object 1104, e.g., a vehicle. The link mechanism 202, for instance, supports the tool body 102 of the hitch vise 1000. Thus, the hitch vise 1000 is positioned such that the vise mechanism 108 is in a substantially parallel position to a surface such as the ground and can be used as a vise, such as to grip a workpiece. For instance, the handle 106 can be rotated in a first direction to open the vise mechanism 108 and in a second direction to close the vise mechanism 108.

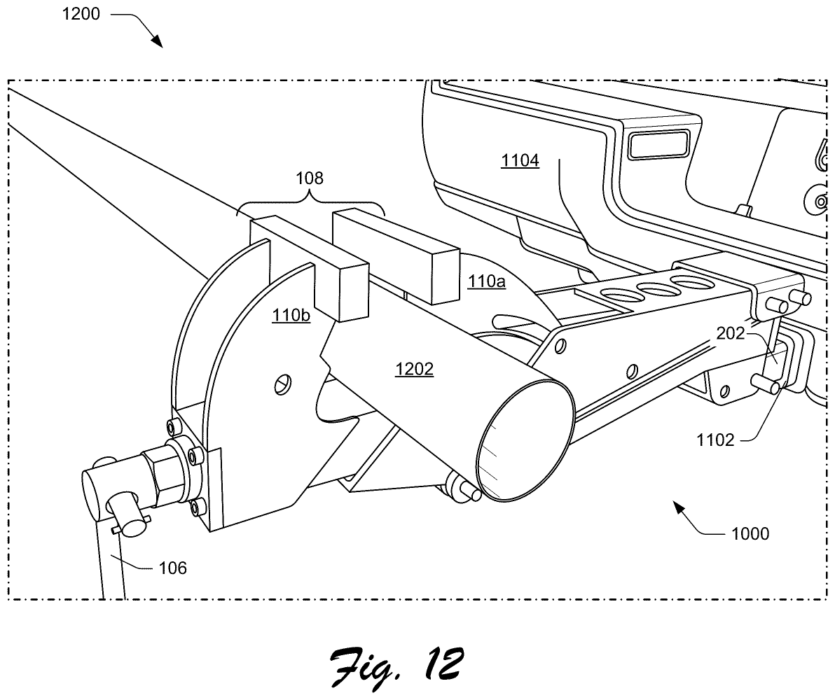

FIG. 12 depicts an example implementation of the hitch vise 1000 utilized in a scenario 1200 in accordance with one or more implementations. The scenario 1200, for instance, represents a continuation of the scenario 1100. In the scenario 1200 the link mechanism 202 is placed within the receptacle 1102 (e.g., a hitch receiver) of an object 1104, e.g., a vehicle. Further, the vise mechanism 108 is manipulated via rotation of the handle 106 such as detailed throughout this disclosure to enable a workpiece 1202 to be secured within the vise mechanism 108, e.g., between the first jaw 110a and the second jaw 110b.

For instance, rotating the handle 106 in a first direction opens the vise mechanism 108 (e.g., causes the second jaw 110b to move away from the first jaw 110a) to enable placement of the workpiece 1202 within the vise mechanism 108, e.g., between the first jaw 110a and the second jaw 110b. Further, rotating the handle 106 in a second direction closes the vise mechanism 108 (e.g., causes the second jaw 110b to move toward the first jaw 110a), such as to clamp the workpiece 1202 within the vise mechanism 108.

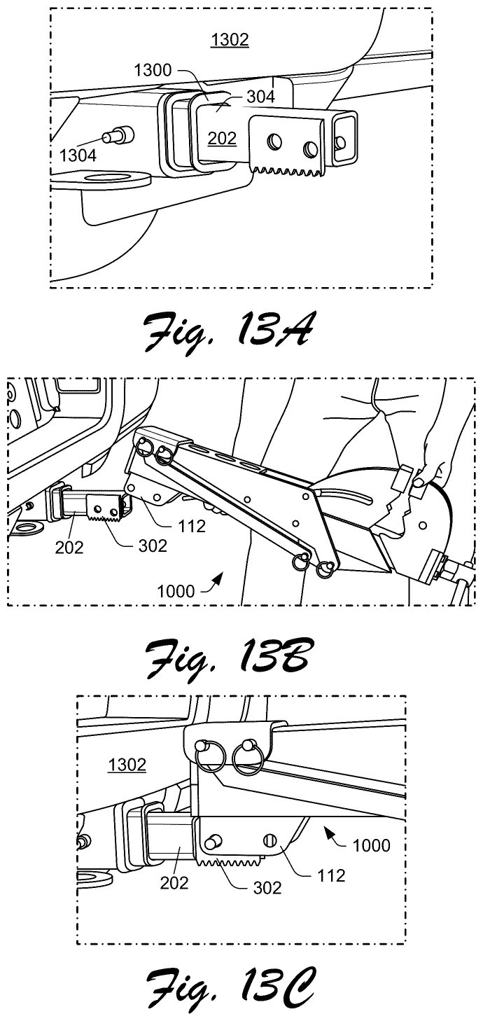

FIGS. 13A, 13B, 13C depict implementations for using the link mechanism 202 in conjunction with the multi-purpose tool 100 in accordance with one or more implementations. For instance, FIG. 13A depicts that the second end 304 of the link mechanism 202 is inserted into a receptacle 1300 of an object 1302, e.g., a hitch receiver of a vehicle. A fastener 1304, for instance, is placed through apertures in the receptacle 1300 and an aperture 310 in the second end 304 of the link mechanism 202 to secure the link mechanism 202 within the receptacle 1300.

FIG. 13B depicts that the brackets 112 of the hitch vise 1000 can be positioned to be attached to the first end 302 of the link mechanism 202, such as described above. FIG. 13C depicts the hitch vise 1000 with the brackets 112 attached to the first end 302 of the link mechanism 202. For instance, an attachment mechanism such as fastener is utilized to attach the brackets 112 to the link mechanism 202. Thus, with the multi-purpose tool 100 attached to the object 1302 in this way, the multi-purpose tool 100 can be utilized in various ways, such as in a hitch vise implementation such as described with reference to FIGS. 10-12.

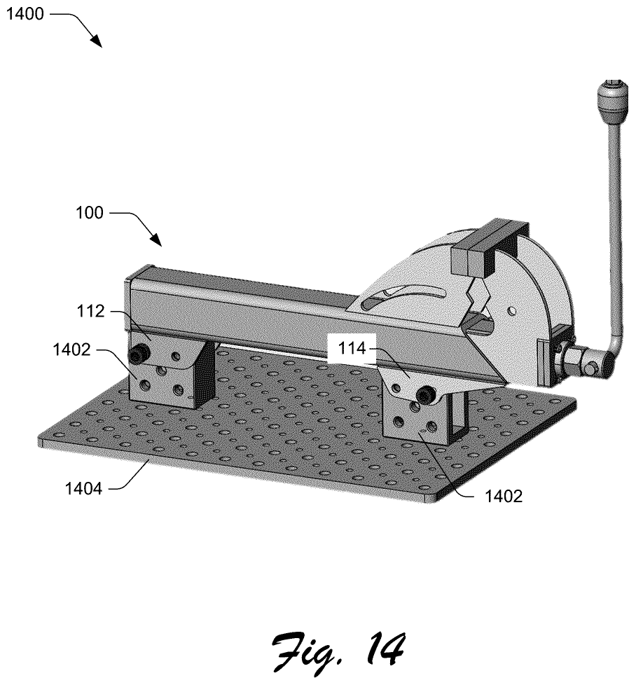

FIG. 14 depicts an implementation of the multi-purpose tool 100 in a scenario 1400 for attachment to an adjacent surface. For instance, the multi-purpose tool 100 is attached via attachment of the brackets 112, 114 to attachment blocks 1402, and attachment of the attachment blocks 1402 to an adjacent surface 1404. The adjacent surface 1404, for instance, represents a grid surface with apertures such as a welding table. Further, attachment mechanisms such as fasteners can be utilized to attach the attachment blocks 1402 to the adjacent surface 1404.

Implementations discussed herein utilize fasteners for various purposes such as for reconfigurably assembling the multi-purpose tool 100 in a variety of different implementations. Various types of fasteners may be utilized such as pins, bolts, studs, etc. The implementations described and claimed herein, however, are not limited to any particular type of fastener.

Implementations described herein include but are not limited to:

In some aspects, the techniques described herein relate to a multi-purpose tool including: a tool body; a tool insert slidably inserted into the tool body; a vise mechanism including a first jaw attached to the tool body and a second jaw attached to the tool insert, the first jaw and the second jaw being operable to open and close relative to one another via movement of the tool insert relative to the tool body; and a lift mechanism reconfigurably attachable to one or more of the tool body or the tool insert, the lift mechanism being operable to extend and contract relative to the tool body.

In some aspects, the techniques described herein relate to a multi-purpose tool, further including a handle attached to the tool insert, the handle being manipulable to cause slidable movement of the tool insert within the tool body.

In some aspects, the techniques described herein relate to a multi-purpose tool, further including a link mechanism attached to the second jaw and the lift mechanism, the link mechanism enabling extension and contraction of the lift mechanism via slidable movement of the tool insert relative to the tool body.

In some aspects, the techniques described herein relate to a multi-purpose tool, further including a link mechanism pivotably attached to the second jaw, the link mechanism being positionable in a first position wherein the link mechanism is substantially parallel to the tool body and a second position wherein the link mechanism is substantially perpendicular to the tool body.

In some aspects, the techniques described herein relate to a multi-purpose tool, wherein the lift mechanism includes a set of lift arms reconfigurably attachable to the tool body, wherein in the first position of the link mechanism the set of lift arms is attached to the link mechanism, and in the second position of the link mechanism the set of lift arms are attached to a peripheral end of the tool body and is operable as a support mechanism for the multi-purpose tool.

In some aspects, the techniques described herein relate to a multi-purpose tool, wherein the lift mechanism includes a set of lift arms reconfigurably attachable to the tool body and a set of extension arms reconfigurably and alternately attachable to the tool body or the second jaw.

In some aspects, the techniques described herein relate to a multi-purpose tool, wherein the lift mechanism is configurable in multiple configurations including: a first configuration in which the set of lift arms and the set of extension arms are attached to a lift platform in a scissor configuration and are operable to extend the lift platform relative to the tool body; and a second configuration in which the set of lift arms and the set of extension arms are attached to the lift platform in a substantially parallel position and are operable to extend the lift platform relative to the tool body.

In some aspects, the techniques described herein relate to a multi-purpose tool, wherein in the first configuration the set of lift arms is attached to a peripheral end of the tool body and the set of extension arms is attached to the second jaw.

In some aspects, the techniques described herein relate to a multi-purpose tool, further including a link mechanism attached to the second jaw and the lift mechanism, wherein in the second configuration the set of lift arms is attached to the link mechanism and the tool body.

In some aspects, the techniques described herein relate to a multi-purpose tool, wherein in the second configuration the set of lift arms is engaged with guide channels formed within the first jaw.

In some aspects, the techniques described herein relate to a multi-purpose tool including: a tool body; a tool insert slidably inserted into the tool body; a vise mechanism including a first jaw attached to the tool body and a second jaw attached to the tool insert, the first jaw and the second jaw being operable to open and close relative to one another via movement of the tool insert relative to the tool body; and a link mechanism reconfigurably attachable to the multi-purpose tool in multiple configurations, the multiple configurations including: a first configuration in which the link mechanism is attached to a peripheral end of the tool body to enable attachment of the multi-purpose tool to an object via engagement of the link mechanism with the object; and a second configuration in which the link mechanism is attached to the second jaw such that the second jaw supports the link mechanism in a position that is substantially perpendicular to the tool body.

In some aspects, the techniques described herein relate to a multi-purpose tool, wherein in the first configuration the link mechanism is substantially parallel to the tool body.

In some aspects, the techniques described herein relate to a multi-purpose tool, wherein in the first configuration when the link mechanism is engaged with the object, the link mechanism supports the tool body.

In some aspects, the techniques described herein relate to a multi-purpose tool, wherein in the second configuration movement of the tool insert relative to the tool body causes corresponding movement of the link mechanism relative to the tool body.

In some aspects, the techniques described herein relate to a multi-purpose tool, wherein the multiple configurations further include a third configuration in which the link mechanism is attached to the second jaw at a first end of the link mechanism and attached to a lift mechanism at a second end of the link mechanism.

In some aspects, the techniques described herein relate to a multi-purpose tool, wherein in the third configuration the link mechanism is operable to cause movement of the lift mechanism in response to movement of the tool insert.

In some aspects, the techniques described herein relate to a multi-purpose tool including: a tool body; a tool insert slidably inserted into the tool body; and a set of lift arms reconfigurably attachable to the tool body in multiple configurations, the multiple configurations including: a first configuration in which the set of lift arms and a set of extension arms are attached to a lift platform in a scissor configuration and are operable to extend the lift platform relative to the tool body; and a second configuration in which the set of lift arms and the set of extension arms are attached to the lift platform in a substantially parallel position and are operable to extend the lift platform relative to the tool body.

In some aspects, the techniques described herein relate to a multi-purpose tool, wherein in the first configuration the set of lift arms is attached to a peripheral end of the tool body and the set of extension arms is attached to a jaw structure of the tool insert.

In some aspects, the techniques described herein relate to a multi-purpose tool, further including a link mechanism attached to a jaw structure of the tool insert and attached to the set of lift arms to enable movement of the lift platform in response to movement of the tool insert and according to the second configuration.

In some aspects, the techniques described herein relate to a multi-purpose tool, further including a vise mechanism including a first jaw attached to the tool body and a second jaw attached to the tool insert, the first jaw and the second jaw being operable to open and close relative to one another via movement of the tool insert relative to the tool body.

What is claimed is:

1. A multi-purpose tool comprising:
a tool body;
a tool insert slidably inserted into the tool body;
a vise mechanism including a first jaw attached to the tool body and a second jaw attached to the tool insert, the first jaw and the second jaw being operable to open and close relative to one another via movement of the tool insert relative to the tool body; and
a lift mechanism reconfigurably attachable to one or more of the tool body or the tool insert, the lift mechanism being operable to extend and contract relative to the tool body.

2. The multi-purpose tool as described in claim 1, further comprising a handle attached to the tool insert, the handle being manipulable to cause slidable movement of the tool insert within the tool body.

3. The multi-purpose tool as described in claim 1, further comprising a link mechanism attached to the second jaw and the lift mechanism, the link mechanism enabling extension and contraction of the lift mechanism via slidable movement of the tool insert relative to the tool body.

4. The multi-purpose tool as described in claim 1, further comprising a link mechanism pivotably attached to the second jaw, the link mechanism being positionable in a first position wherein the link mechanism is substantially parallel to the tool body and a second position wherein the link mechanism is substantially perpendicular to the tool body.

5. The multi-purpose tool as described in claim 4, wherein the lift mechanism comprises a set of lift arms reconfigurably attachable to the tool body, wherein in the first position of the link mechanism the set of lift arms is attached to the link mechanism, and in the second position of the link mechanism the set of lift arms are attached to a peripheral end of the tool body and is operable as a support mechanism for the multi-purpose tool.

6. The multi-purpose tool as described in claim 1, wherein the lift mechanism comprises a set of lift arms reconfigurably attachable to the tool body and a set of extension arms reconfigurably and alternately attachable to the tool body or the second jaw.

7. The multi-purpose tool as described in claim 6, wherein the lift mechanism is configurable in multiple configurations including:
a first configuration in which the set of lift arms and the set of extension arms are attached to a lift platform in a scissor configuration and are operable to extend the lift platform relative to the tool body; and
a second configuration in which the set of lift arms and the set of extension arms are attached to the lift platform in a substantially parallel position and are operable to extend the lift platform relative to the tool body.

8. The multi-purpose tool as described in claim 7, wherein in the first configuration the set of lift arms is attached to a peripheral end of the tool body and the set of extension arms is attached to the second jaw.

9. The multi-purpose tool as described in claim 7, further comprising a link mechanism attached to the second jaw and the lift mechanism, wherein in the second configuration the set of lift arms is attached to the link mechanism and the tool body.

10. The multi-purpose tool as described in claim 9, wherein in the second configuration the set of lift arms is engaged with guide channels formed within the first jaw.

11. A multi-purpose tool comprising:
a tool body;
a tool insert slidably inserted into the tool body;
a vise mechanism including a first jaw attached to the tool body and a second jaw attached to the tool insert, the first jaw and the second jaw being operable to open and close relative to one another via movement of the tool insert relative to the tool body; and
a link mechanism reconfigurably attachable to the multi-purpose tool in multiple configurations, the multiple configurations including:
a first configuration in which the link mechanism is attached to a peripheral end of the tool body to enable attachment of the multi-purpose tool to an object via engagement of the link mechanism with the object; and
a second configuration in which the link mechanism is attached to the second jaw such that the second jaw supports the link mechanism in a position that is substantially perpendicular to the tool body.

12. The multi-purpose tool as described in claim 11, wherein in the first configuration the link mechanism is substantially parallel to the tool body.

13. The multi-purpose tool as described in claim 11, wherein in the first configuration when the link mechanism is engaged with the object, the link mechanism supports the tool body.

14. The multi-purpose tool as described in claim 11, wherein in the second configuration movement of the tool insert relative to the tool body causes corresponding movement of the link mechanism relative to the tool body.

15. The multi-purpose tool as described in claim 11, wherein the multiple configurations further comprise a third configuration in which the link mechanism is attached to the second jaw at a first end of the link mechanism and attached to a lift mechanism at a second end of the link mechanism.

16. The multi-purpose tool as described in claim 15, wherein in the third configuration the link mechanism is operable to cause movement of the lift mechanism in response to movement of the tool insert.

17. A multi-purpose tool comprising:
a tool body;
a tool insert slidably inserted into the tool body; and
a set of lift arms reconfigurably attachable to the tool body in multiple configurations, the multiple configurations including:
a first configuration in which the set of lift arms and a set of extension arms are attached to a lift platform in a scissor configuration and are operable to extend the lift platform relative to the tool body; and
a second configuration in which the set of lift arms and the set of extension arms are attached to the lift platform in a substantially parallel position and are operable to extend the lift platform relative to the tool body.

18. The multi-purpose tool as described in claim 17, wherein in the first configuration the set of lift arms is attached to a peripheral end of the tool body and the set of extension arms is attached to a jaw structure of the tool insert.

19. The multi-purpose tool as described in claim 17, further comprising a link mechanism attached to a jaw structure of the tool insert and attached to the set of lift arms to enable movement of the lift platform in response to movement of the tool insert and according to the second configuration.

20. The multi-purpose tool as described in claim 17, further comprising a vise mechanism including a first jaw attached to the tool body and a second jaw attached to the tool insert, the first jaw and the second jaw being operable to open and close relative to one another via movement of the tool insert relative to the tool body.
